(19) United States
(12) Patent Application Publication
(10) Pub. No.: US 2012/0010863 A1
(43) Pub. Date: Jan. 12, 2012

(54) SIMULATOR AND VEST FOR SIMULATING THE STRESSES ON A HUMAN BODY BEING GENERATED IN THE COURSE OF THE MOVEMENT OF A VEHICLE

(76) Inventor: ALEXEY BORISOVICH LUKYANOV, Jaroslavl (RU)

(21) Appl. No.: 12/859,154

(22) Filed: Aug. 18, 2010

(30) Foreign Application Priority Data
Aug. 26, 2009 (RU) 2009132054/77

(51) Int. Cl. G06G 7/70; A41D 1/04

(52) U.S. Cl. 703/8; 2/102

(57) ABSTRACT

The invention relates to a simulator for simulating the stresses on a human body generated in the course of the movement of a vehicle, having a control element, a control unit, a display device of the surroundings and actuating elements. So that the full imitation of all physical inertia forces acting on the human body in the course of the various driving conditions is achieved, the invention provides that the control unit is connected with the actuating elements, and that the actuating elements are connected with the human body by means of an element (vest 8) directly acting on the body.

### CROSS-REFERENCE TO RELATED APPLICATION

This application claims the benefit of the priority filing date in Russian Application No. 2009132054/77. The earliest priority date claimed is Aug. 26, 2009.

### FEDERALLY SPONSORED RESEARCH

None

### SEQUENCE LISTING OR PROGRAM

None

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The invention relates to a simulator and vest for simulating the stresses on a human body being generated in the course of the movement of a vehicle, having a control element, a control unit, a display device of the surroundings and actuating elements.

Simulators which imitate the movement of a vehicle can be employed in connection with the training of motorists, airplane and helicopter pilots, and for amusement purposes.

An amusement device imitating a movement is known, which is embodied as follows: A passenger compartment is designed with four windows. The base of the compartment is stepped. The seats are additionally equipped with a device for imitating stresses. The arm and head rests of the seats are designed to be movable. Each seat is equipped with a device for dynamically changing the seat position and a seat position sensor. The display of the movable image is embodied in the form of movie or video projectors, one to four display screens with flaps, opening mechanisms for the flaps and flap-position sensors, one to four mirrors and a unit for controlling and monitoring the flap position. A sound reproduction system, a lighting system, and a display system are arranged in the compartment. The control of the system is performed by means of a device for the generation of control signals for the seats, a control and monitoring unit for a sound reproduction system, and a control and monitoring unit for lighting and display (RF patent application No. 940078814). For letting the passengers in and out, the compartment is equipped with doors with opening mechanisms, position sensors and lock chambers with stairs, and mechanisms for stair control and position sensors. Control is performed by means of signals from a unit for controlling and monitoring the doors and windows.

A simulator for aircraft pilots is also known. It contains a base, a seat, a control unit with the option of imitating the surroundings, position sensors for control elements and a device for displaying the surroundings. The simulator is distinguished in that it is equipped with power elements for positional changes. Each one of these power elements is connected with a power source for a regulator. The seat of a changeable length is placed on the power elements, and the power elements can be tilted in respect to the base (Utility Model RF 70397). The power elements are embodied as hydraulic cylinders, and the energy source as an installation with hydraulic motors. The device for displaying the surroundings is embodied as a virtual reality helmet having screens and devices for reproducing audio signals. The simulator has a control wheel and pedals for control elements, which can change their position by means of the application of power. Here, the power is intended to exceed a rated power.

In regard to all essential characteristics, the simulator in accordance with Utility Model RF 70397 comes closest to the applied-for utility model and has been selected as a prototype.

The disadvantage of the known technical embodiments is a lack of a directed physical action on different body parts of a human being in connection with directional changes, such as acceleration, braking of the vehicle, or altitude gain of the aircraft, either separately or in various combinations.

It is the object of the present invention to achieve a complete imitation of all physical inertia forces acting on the human body in the course of various modes of movement of the vehicle.

The intended object is attained by means of the characteristics of claim 1. This is achieved in the following manner: The simulator has control elements for the vehicle, a control unit designed as a computer for representing and displaying the surroundings. The computer is connected with a control device which, via actuating elements, drives an element acting on the body. This element is embodied as a vest worn by the human being placed on the seat. The actuating elements can be embodied as a joystick of an aircraft, or as the steering wheel or acceleration and brake pedal of a ground vehicle. The device for displaying the surroundings is embodied as a virtual reality helmet, or in the form of stationary monitors. The control device can be embodied as a thyristor control unit. The actuating elements can be designed in the form of step motors or as pneumatic (hydraulic) cylinders, whose output members are combined into a lever, which is connected with a back part of the vest. The actuating elements can be fastened on the seat in such a way that the lever has three degrees of freedom and can move the vest, together with the body of the human being, to the right, left, upward, downward, forward and to the rear, or in various combinations thereof.

The vest represents a system of straps extending around the body of the human being at the top (shoulders), bottom (posterior) and around the chest. The straps are connected in the back part of the vest, which can be actuated by means of the lever of the actuating elements. Following the commands of the control device, the lever can move the back part of the vest, together with the body of the human being wearing the vest, as described above, in various directions and at various accelerations. The accelerations are calculated by the computer as a function of the commands received by the control devices.

### SUMMARY

The invention relates to a simulator for simulating the stresses on a human body generated in the course of the movement of a vehicle, having a control element, a control unit, a display device of the surroundings and actuating elements. So that the full imitation of all physical inertia forces acting on the human body in the course of the various driving conditions is achieved, the invention provides that the control unit is connected with the actuating elements, and that the actuating elements are connected with the human body by means of an element (vest) directly acting on the body.

### BRIEF DESCRIPTION OF THE DRAWINGS

The invention will be explained in greater detail by means of an exemplary embodiment represented in the drawings. Shown are in:

FIG. 1, a block circuit diagram of the proposed simulator,

FIG. 2, a lateral view of the actuating elements, of the seat and of the vest, and

FIG. 3, an axonometric view of the vest.

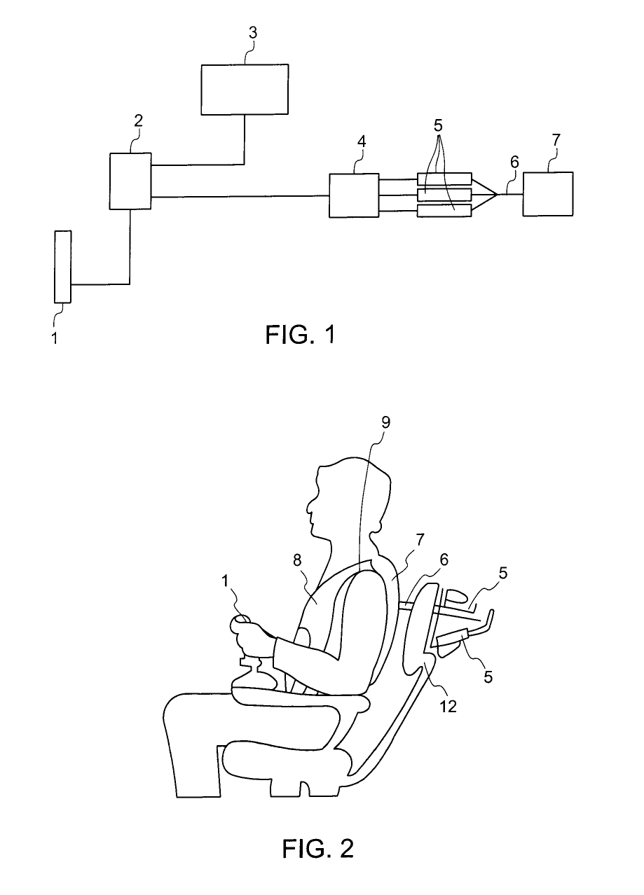

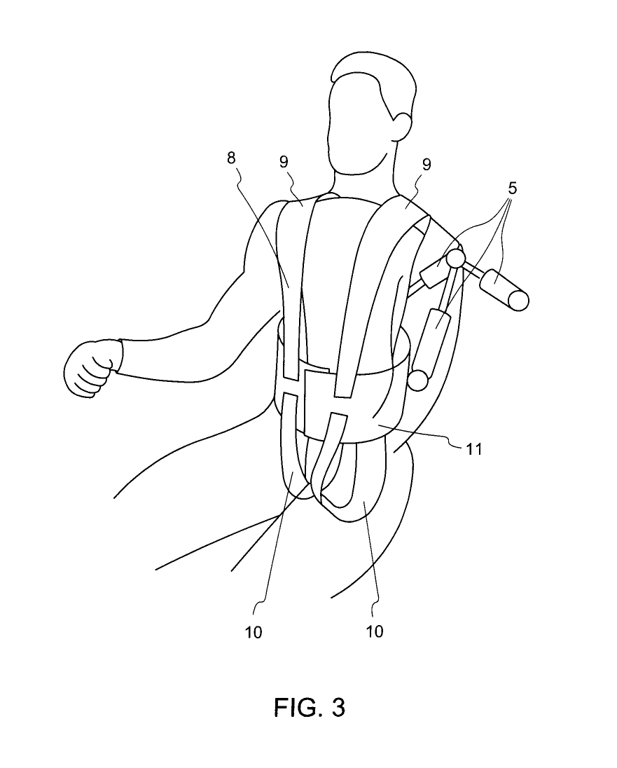

### DESCRIPTION OF THE PREFERRED EMBODIMENT

The simulator consists of:

a control element 1, embodied in the form of a joystick of an aircraft or as the steering wheel of a ground vehicle,

a control unit 2 embodied in the form of a computer,

a display device 3 of the surroundings, for example in the form of a virtual reality helmet or as stationary monitors.

The control unit 2 is connected with the display device 3 and a control device 4. The control device 4 is connected with actuating elements 5, whose output members are united in a lever 6. The lever 6 is connected with a back part 7 of the vest 8.

The vest 8 is embodied in the form of a system of straps. The system has upper straps 9, which extend around the shoulders of the human being, lower straps 10, which extend around the posterior, and a strap 11, enclosing the human being at the circumference of the chest. The actuating elements 5 are fastened on a seat 12, for example on a backrest, through which the lever 6 acts on the back part 7 of the vest 8.

The simulator functions in the following manner: The human being (pilot) puts on the vest 8 and tightens the straps 9, 10 and 11. Thereafter, with the aid of the control elements 1, he selects the modes of operation to be displayed on the display device 3. The control unit 2 processes the orders from the control element 1. The latter calculates the acceleration acting on the virtual pilot, and therefore on the actual pilot. Thereafter, it calculates the movement of the lever 6 of the vest 8 and issues an order to the actuating elements 5, which act together on the lever 6. In turn, the lever 6 moves the back part 7 of the vest 8. In the imitation of the vehicle moving toward the left, the vest 8 pulls the human body toward the right, in the imitation of the vehicle moving toward the right, the vest 8 pulls the body toward the left. When imitating an acceleration, the vest 8 pulls the body back against the seat, when braking, toward the front. When imitating a gain in altitude, the vest 8 pulls the body downward, when imitating a descent, upward. All this is possible when imitating one mode of operating, as well as a plurality of modes of operation, in connection with which the control unit 2 calculates the movement of the lever 6, and therefore of the vest 8. In this way a complete imitation of the forces (stresses) acting on the body in the course of the virtual steering of the vehicle is attained.

What is claimed is:

1. A simulator for simulating the stresses on a human body being generated in the course of the movement of a vehicle and having a control element (1), a control unit (2), a display device (3) of the surroundings and actuating elements (5), characterized in that
the control unit (2) is connected with the actuating elements (5), and
the actuating elements (5) are connected with the human body by means of an element (vest 8) directly acting on the body.

2. The simulator in accordance with claim 1,
characterized in that the control elements (1) are embodied in the form of a joystick of an aircraft, or as a steering wheel, and acceleration and braking pedals of a ground vehicle.

3. The simulator in accordance with claim 1,
characterized in that
the display device (3) is embodied for displaying the surroundings by means of a virtual reality helmet, or of stationary monitors.

4. The simulator in accordance with claim 1,
characterized in that
the actuating elements (5) are embodied as electric motors, whose output devices are connected with a vest (8).

5. The simulator in accordance with claim 1,
characterized in that
the electric motors are embodied as step motors.

6. The simulator in accordance with claim 1,
characterized in that
the actuating elements (5) are embodied as hydraulic (pneumatic) cylinders, which are connected with a pressure source via the control devices (1, 2, 4).

7. The simulator in accordance with claim 4,
characterized in that
the outlet of the actuating elements (5) is embodied as a lever (6), which is connected with a back part (7) of the element (vest 8) which acts directly on the body.

8. The simulator in accordance with claim 5,
characterized in that
the outlet of the actuating elements (5) is embodied as a lever (6), which is connected with a back part (7) of the element (vest 8) which acts directly on the body.

9. The simulator in accordance with claim 1,
characterized in that
the element which acts directly on the body is embodied as a vest (8).

10. A vest for simulating the stresses on the human body which are generated in the course of the movement of a vehicle,
characterized in that
it has a system of straps (9, 10, 11), which extend around the body of the human being at the top (shoulders), bottom (posterior) and around the circumference of the chest.

11. The vest in accordance with claim 9,
characterized in that
the straps (9, 10, 11) are connected at the back part (7) of the vest (8).

12. The vest in accordance with claim 10,
characterized in that
the back part (7) of the vest (8) is connected with the lever (6) of the actuating elements (5) by means of a hinged connection.
